(19) United States
(12) Patent Application Publication
(10) Pub. No.: US 2026/0323034 A1
(43) Pub. Date: Oct. 15, 2026

(54) ENCODING AND DECODING METHODS USING PARALLEL PROCESSING AND CORRESPONDING APPARATUSES

(71) Applicant: InterDigital CE Patent Holdings, SAS, Paris (FR)

(72) Inventors: Edouard FRANCOIS, BOURG DES COMPTES (FR); Karam NASER, MOUAZE (FR); Antoine ROBERT, MEZIERES SUR COUESNON (FR); Ya CHEN, RENNES (FR)

(21) Appl. No.: 19/485,115

(22) PCT Filed: May 7, 2024
(86) PCT No.: PCT/EP2024/062530

§ 371 Date: Nov. 17, 2025

(30) Foreign Application Priority Data
May 16, 2023 (EP) 23305786.8

(51) Int. Cl. H04N 19/136; H04N 19/132; H04N 19/172; H04N 19/176

(52) U.S. Cl. CPC H04N 19/136; H04N 19/132; H04N 19/172; H04N 19/176

(57) ABSTRACT

A prediction method is disclosed. A block vector is first obtained for a current picture block. It is then determined whether a reference block identified by the block vector is at least partly inside an authorized area, wherein the authorized area is a picture area already processed. The block vector may then be modified responsive to the determining so that the reference block identified by the modified block vector is located at least partly in the authorized area. Finally, the current picture block is predicted from a reference block identified by the modified block vector.

### CROSS REFERENCE TO RELATED APPLICATIONS

This application claims the benefit of European Application No. 23305786.8, filed on May 16, 2023 which is incorporated herein by reference in its entirety.

### TECHNICAL FIELD

At least one of the present embodiments generally relates to a method and an apparatus for encoding and decoding a picture block using parallel processing, e.g. wavefront parallel processing.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one implementation, it is determined whether a reference block of a current picture block identified by a block vector is at least partly (fully respectively) inside an authorized area, wherein the authorized area is a picture area already processed, e.g. by wavefront parallel processing. In an example, the block vector is modified so that the reference block identified by the modified block vector is located at least partly (fully respectively) in the authorized area. The modified block vector may then be used on the encoder or decoder side to predict the current picture block. In an example, the samples of the reference block located outside the authorized area are padded from neighboring samples located inside the authorized area prior to predicting the current picture block.

In an example, modifying the block vector comprises clipping its coordinates to ensure the above constraint (the reference block identified by the modified block vector being located at least partly or fully in the authorized area) is fulfilled.

In another example, a candidate list of candidate blocks used for encoding (decoding respectively) the current picture block may be updated by excluding, from the candidate list, the candidate blocks not at least partly in the authorized area, i.e. the candidate blocks fully outside the authorized area. In a variant, the candidate list is updated by excluding, from the candidate list, the candidate blocks not fully inside the authorized area, i.e. the candidate blocks partly or fully outside the authorized area.

### BRIEF DESCRIPTION OF THE DRAWINGS

FIG. 1 illustrates a block diagram of a system within which aspects of the present embodiments may be implemented;

FIG. 2A illustrates a block diagram of an embodiment of a video encoder;

FIG. 2B illustrates a picture partitioned into various structures;

FIG. 3 illustrates a block diagram of an embodiment of a video decoder;

FIG. 4 illustrates the principle of intra template matching;

FIG. 5 illustrates the principle of block vector;

FIG. 6 illustrates inter template matching performed on a search area around an initial motion vector;

FIG. 7 illustrates the process of LIC (local illumination compensation) parameters estimation in ECM;

FIG. 8 depicts luma and chroma templates to be used for CCLM (cross-component linear model) parameter estimation;

FIG. 9A and FIG. 9B depict a current block whose template extend across subpicture borders;

FIG. 10 illustrates the process of wavefront parallel processing;

FIG. 11A and FIG. 11B depict a current block whose template extend across subpicture borders whose left part is removed from template;

FIG. 12A and FIG. 12B depict a current block whose template extend across subpicture borders whose left part is modified;

FIG. 13A and FIG. 13B depict a current block whose template extend across subpicture borders whose left part is padded;

FIG. 14 illustrate the principle of limiting template size at border of a coding tree unit (CTU);

FIG. 15 depicts a flowchart of a decoding method according to a specific embodiment;

FIG. 16 depicts a flowchart of an encoding method according to a specific embodiment;

FIG. 17A represent a picture divided in CTUs (Coding Tree Units) wherein a current block refers to a reference block of a former CTU;

FIG. 17B represent a picture divided in CTUs wherein a current block refers to a reference block of a former CTU in case of wavefront parallel processing with a lag parameter of 2 CTUs;

FIG. 18 depicts a flowchart of a prediction method according to a specific embodiment;

FIG. 19 illustrates wavefront parallel decoding of a current block in case of three parallel threads with a lag parameter of 2 CTUs;

FIG. 20 illustrates a specific example of a current block prediction with a block vector BV of sub-pel accuracy;

FIG. 21 illustrates the padding of a reference block that is partly inside an authorized area and partly outside;

FIG. 22 depicts a flowchart of a prediction method according to a variant of the method depicted on FIG. 18; and

FIG. 23 depicts a flowchart of a method for updating a candidate list of a current block according to an embodiment.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

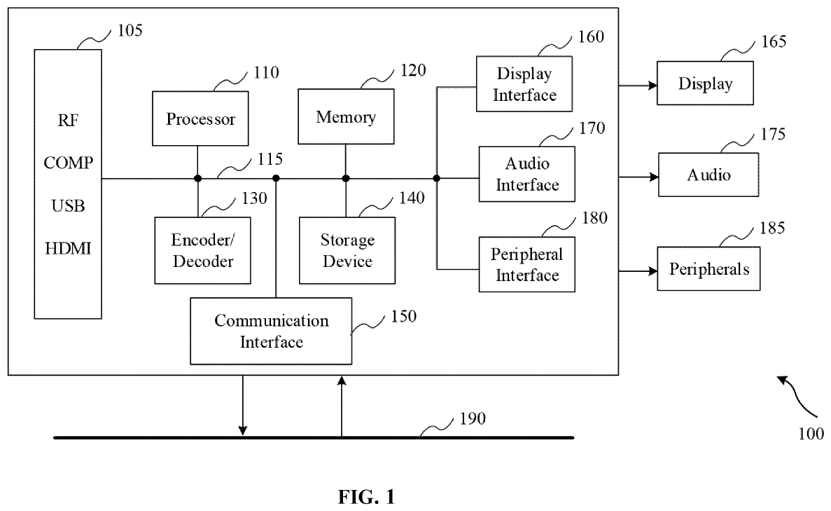

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side. In the present application, the terms “dequantization” and “scaling” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

For the sake of clarity, satisfying, failing to satisfy a condition and configuring condition parameter(s) are described throughout embodiments described herein as relative to a threshold (e.g., greater, or lower than), a (e.g., threshold) value, configuring the (e.g., threshold) value, etc.). For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

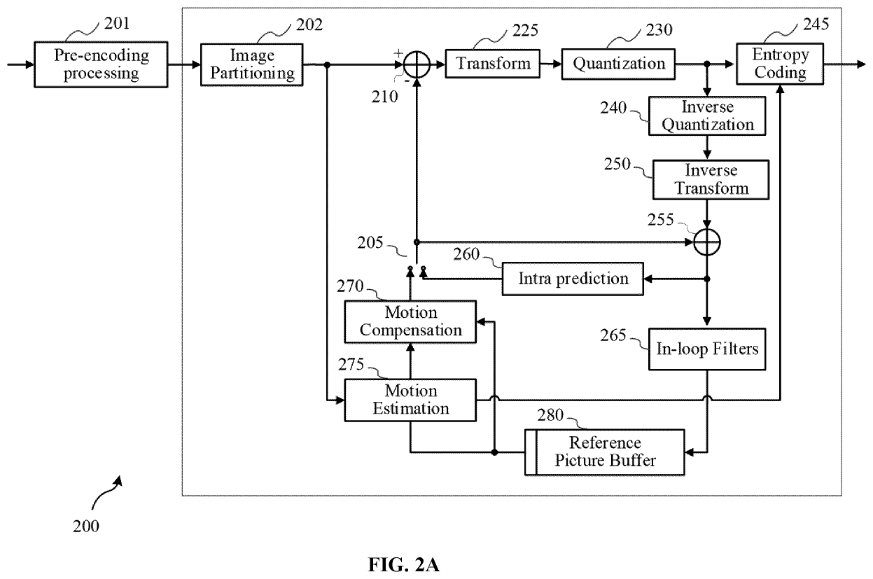

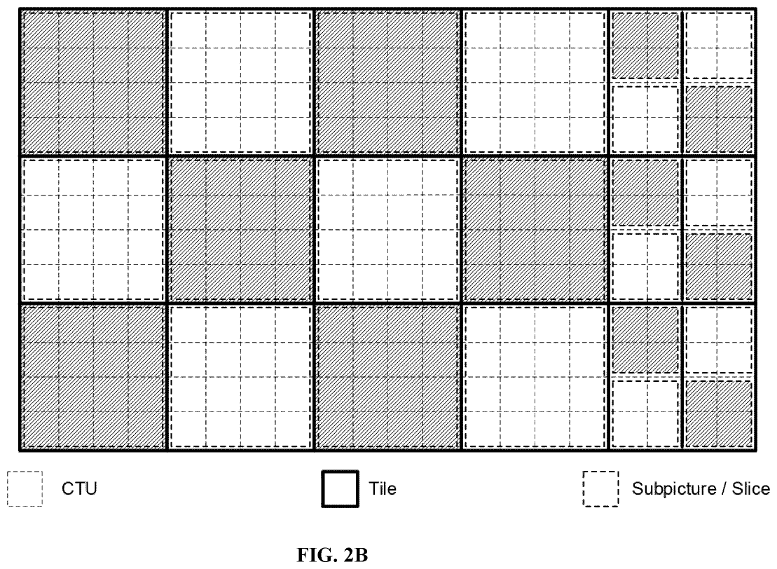

FIG. 2A illustrates an example video encoder 200, such as a VVC (Versatile Video Coding) encoder. FIG. 2A may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CTU (Coding Tree Unit) recursively split into CUs (Coding Units), Transform Unit (TU), and possibly Prediction Unit (PU). In addition, the picture can be segmented according to high-level structures such as tiles, slices, subpictures, made of CTUs. Tiles define horizontal and vertical boundaries that partition a picture into tile columns and rows. Slices in VVC have two modes: rectangular slices and raster scan slices. Rectangular slices are of rectangular shape. A rectangular slice consists of either one or more complete tiles or one or more complete CTU rows within a tile. A raster scan slice consists of one or more complete tiles in tile raster scan order and is not necessarily rectangular. A subpicture is a rectangular set of CTUs, that allows for independent coding/decoding and extraction of a rectangular subset of a sequence of pictures, for use cases like viewport-dependent 360 video streaming optimization and region of interest (ROI) applications. In VVC motion vectors in a subpicture can point outside of the subpicture even when the subpicture is extractable, (i.e., the syntax element sps_subpic_treated_as_pic_flag[i] is equal to 1), thus allowing padding at subpicture boundaries in this case, similarly as at picture boundaries. The semantic of sps_subpic_treated_as_pic_flag[i] in the VVC specification is defined as follows: sps_subpic_treated_as_pic_flag[i] equal to 1 specifies that the i-th subpicture of each coded picture in the CLVS (acronym of Coded Layer Video Sequence) is treated as a picture in the decoding process excluding in-loop filtering operations. sps_subpic_treated_as_pic_flag[i] equal to 0 specifies that the i-th subpicture of each coded picture in the CLVS is not treated as a picture in the decoding process excluding in-loop filtering operations. When not present, the value of sps_subpic_treated_as_pic_flag[i] is inferred to be equal to 1.

Each subpicture consists of one or more complete (rectangular) slices. All subpicture's CTUs belong to the same tile. All tile's CTUs belong to the same subpicture. FIG. 2B illustrates one example of picture partitioning into slices, tiles and subpictures.

Each unit is encoded using, for example, either an intra or inter mode. When a unit is encoded in an intra mode, it performs intra prediction (260), e.g. using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block (a.k.a. prediction block) from the original image block.

The prediction residuals are then transformed (225) into transform coefficients c (a.k.a prediction residual transform coefficients) which are quantized (230) into quantization indexes c_{q} (a.k.a transform coefficient levels or quantized transform coefficients on the encoder side). The quantization levels (a.k.a quantization indexes) c_{q}, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280). In-loop filters (265) are thus used to enhance reconstructed images before storing them in the reference picture buffer (280). In-loop filters form a whole family. Among them, deblocking filters (DBF) aim at reducing blocking artifacts occurring along block boundaries. Deblocking filters are usually designed to improve subjective quality, that is, the noticeability of such coding errors by the human psychovisual system. In usual video coding standards such as HEVC and VVC, deblocking filters are predetermined based on coding information (such as prediction modes, motion vectors, transform coefficients) and on local variations across block boundaries. On the other hand, adaptive loop filters (ALF) are learnt at encoder side in order to minimize a mean squared error with respect to source images, then the learned filter weights are encoded into the bitstream. Adaptive loop filters are usually applied at CTU-level, while deblocking filters are applied along block borders.

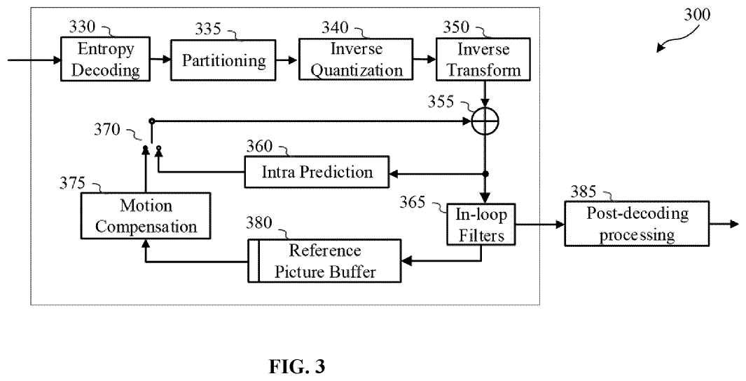

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2A. The encoder 200 also generally performs video decoding as part of encoding video data.

In particular, the input of the decoder includes a video bitstream, which can be generated by video encoder 200. The bitstream is first entropy decoded (330) to obtain quantization levels c_{q} (a.k.a. transform coefficient levels or quantization levels on the decoder side), prediction modes, motion vectors, and other coded information. The picture partition information indicates how the picture is partitioned. The decoder may therefore divide (335) the picture according to the decoded picture partitioning information. The quantization levels c_{q} are de-quantized (340) into reconstructed transform coefficients cᵣ. De-quantization is also named scaling. The reconstructed transform coefficients cᵣ are inverse transformed (350) to obtain the prediction residuals. Combining (355) the prediction residuals and the predicted block (a.k.a. prediction block), an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

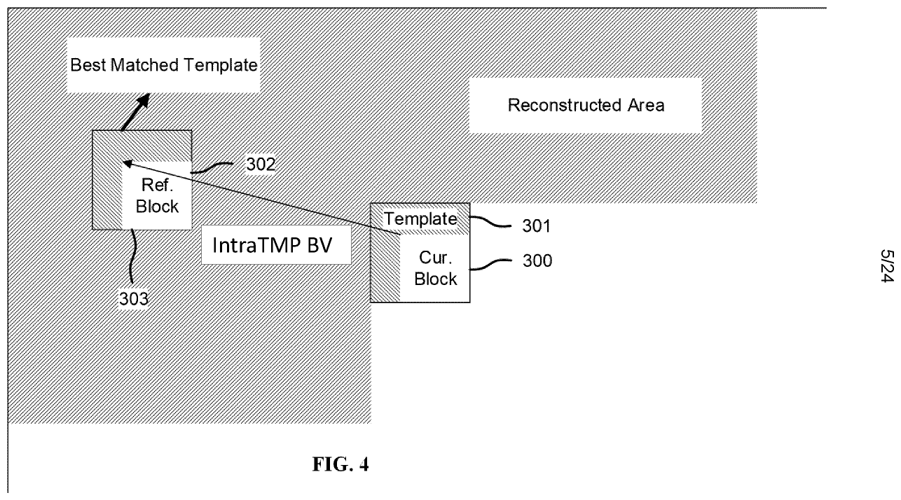

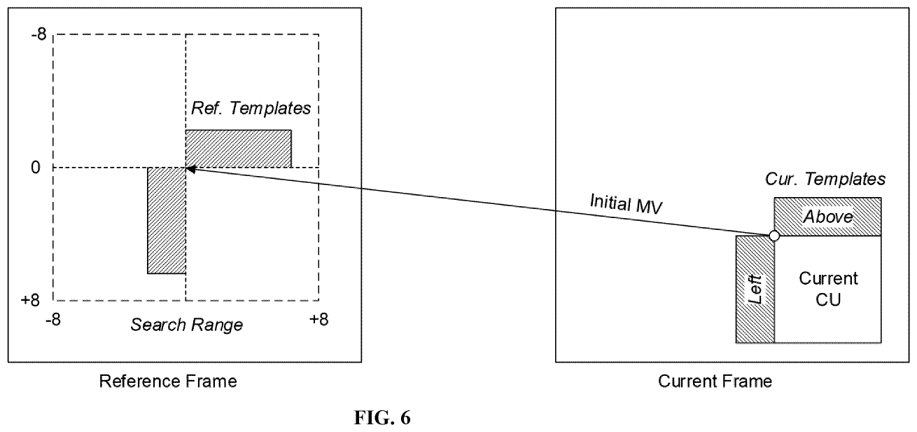

HEVC, VVC, ECM (acronym of Enhanced Compression Model) developed by JVET use multiple template-based tools. For a given block to process, a template is a surrounding area of this block that is used to make computations, decisions or choices based on the samples belonging to this template. The template may have an L-shape as depicted on FIG. 4 or may comprise several disjoint parts as depicted on FIG. 6. However, the present principles are not limited to these specific shapes of template.

In the follows, some template-based tools of ECM and VVC are detailed. The template-based tool is configured to output information to be used for encoding (decoding respectively) a picture block. This information may be of various types such as a prediction of the block to be encoded (decoded respectively), one or more prediction modes for the block to be encoded (decoded respectively), one or more transforms to be used with the block to be encoded, a reordered list of merge candidates to be used for the block to be encoded (decoded respectively), a reordered list of intra coding modes candidates to be used for the block to be encoded (decoded respectively), etc. This list is not exhaustive, and the present embodiments are neither limited to a specific template-based tool nor to a specific type of output information.

### Intra Template Matching

In ECM, Intra Template Matching Prediction (IntraTMP) is an intra prediction mode that predicts a current block to be encoded (decoded respectively).

To this aim, the template (301) of the current block (300) is made of rows of decoded reference samples above the current block and columns of decoded reference samples on its left side, as shown in FIG. 4. In a search step, for each allowed position in given search range of TMP, the candidate reconstructed block (302) whose top-left pixel is positioned at this allowed position is considered, and similarity between its template (303) of rows of decoded reference samples above it and columns of decoded reference samples on its left side and the template (301) of the current block (300) is computed. The similarity is for example computed as a distortion between templates 301 and 303. The selected reconstructed block (best candidate) is the one with minimum template matching distortion. The selected candidate reconstructed block is then used to predict the current block. In an example, the distortion is a sum of absolute differences (SAD) or a sum of square error. The SAD is for example computed as follows:

$$dist = {\sum }_{i = 0}^{N - 1} \vert Cur ( p ) - Ref ( p ) \vert$$

where Cur(p) is the luminance value of pixel p in the current template and Ref(p) is the luminance value of the pixel p in the reference template.

In a specific example, during IntraTMP process, the block vector (IntraTMP BV) between the current block 300 and the reference block 302 can be simply calculated and stored as the block vector of the current block. The IntraTMP block vector can be added as spatial candidates to block vector candidate list for intra block copy (IBC). Therefore, a block can use both IBC BV and IntraTMP BV of neighboring blocks as BV candidate.

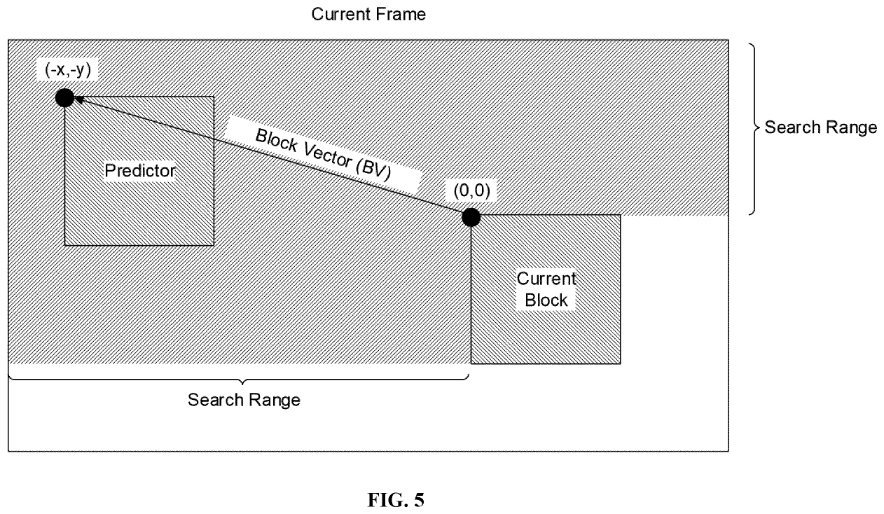

As depicted on FIG. 5, IBC BV is a vector associated with a current block that is transmitted in the bitstream and used for intra prediction of the current block. More precisely, the reference block (a.k.a predictor) identified by the vector BV is either copied (when both BV components have full-pel accuracy) or used for interpolating a block to be copied (when BV has at least one component with subpel accuracy) into the current block.

### Template Matching

Template matching (TM) is a decoder-side Motion Vector (MV) derivation method used to derive or refine the motion information of the current block (a.k.a. CU) by finding the closest match between a current template (i.e., top and/or left neighbouring blocks of the current CU) in the current picture and a reference template (i.e., same size to the current template) in a reference picture. As illustrated in FIG. 6 that illustrates the refinement case, a better MV is searched around the initial motion of the current CU within a [−8, +8]-pel search range. For each tested MV, a distortion is computed between the samples in the template of the current block (current template), and the samples in the template of the reference block (reference template) associated with the MV.

In AMVP (Advanced Motion Vector Prediction) mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel Adaptive Motion Vector Resolution (AMVR) mode), followed sequentially by half-pel or quarter-pel ones. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

In merge mode, similar search method is applied to the merge candidate indicated by the merge index. TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### Local Illumination Compensation

In inter prediction process of the ECM, Local Illumination Compensation (LIC) is a coding tool which is used to address the issue of local illumination changes that exist between temporal neighboring pictures. The LIC is based on a linear model where a scaling factor and an offset β are applied to the reference samples to obtain the prediction samples of a current block. Specifically, the LIC can be mathematically modelled by the following equation:

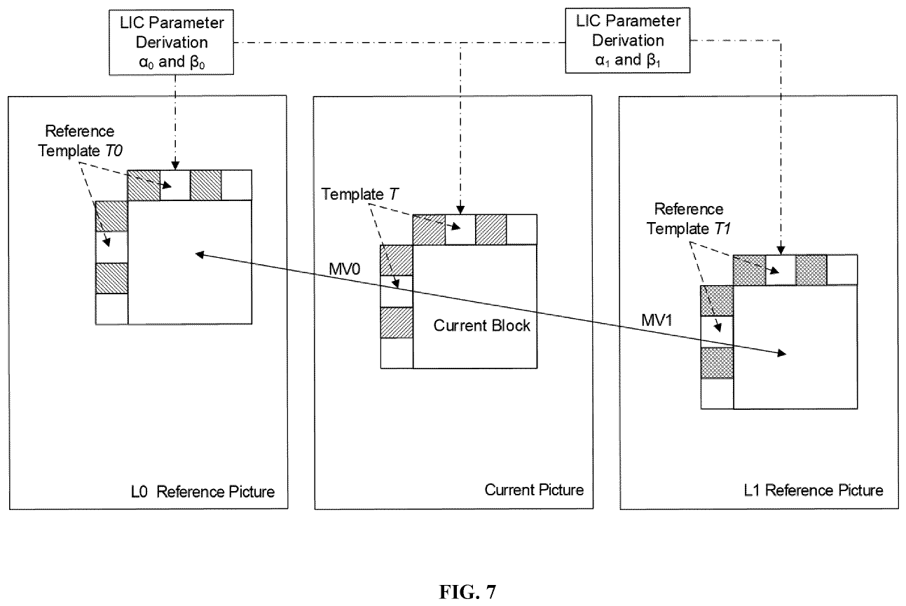

P(x,y) =α*Pᵣ(x+vₓ,y+vy)+β

where P(x, y) is the prediction signal of the current block at the coordinate (x, y); Pᵣ(x+vₓ, y+v_{y}) is a prediction signal obtained from the reference block pointed by the motion vector (vₓ, v_{y}); α and β are the corresponding scaling factor and offset that are applied to the reference block. LIC parameters α and β are computed based on the neighboring template of the current block and of the reference block, as illustrated in FIG. 7 in case of bi-prediction. Typically, intermediate statistical parameters such as min/max samples value, average, inter-correlation, variance are computed, and α and β are then computed from these intermediate statistical parameters.

### Cross-Component Linear Model (CCLM)

Cross-component Linear Model (CCLM) chroma intra prediction included in Versatile Video Coding (VVC) explores the relationship between the luma and chroma components. The chroma samples are predicted based on the reconstructed luma samples of the same CU (a.k.a block) by using a linear model as follows:

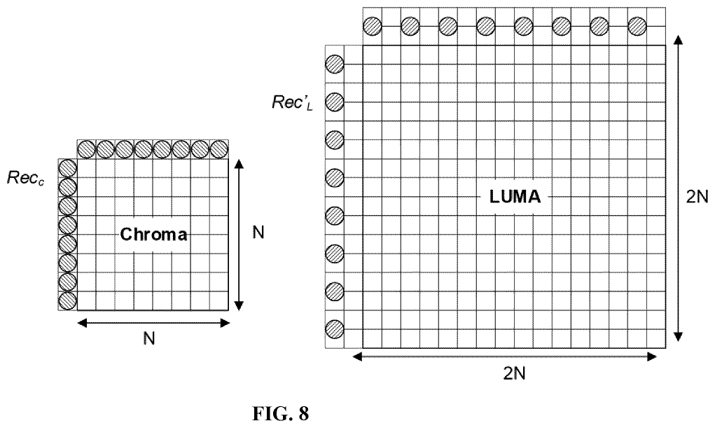

Pred_{c}(x,y)=α*Rec_{L}′(x,y)+β

where Pred_{C}(x, y) represents the predicted chroma samples in a CU at the coordinate (x, y); and Rec_{L}′(x, y) represents the downsampled reconstructed luma samples of the same CU; parameters α and β are derived from the reconstructed samples around the current block as illustrated by FIG. 8.

Similar to the LIC, the CCLM method utilizes the template of current luma and chroma blocks to estimate the parameters α and β from Rec_{C} and Rec_{L}′ samples.

Variants of CCLM (such as gradient linear model, filter-based linear model, convolutional cross-component model) have been developed in ECM, with more models, different types of templates, different types of samples in the template, different estimation methods of the mode parameters. But the approach remains the same and is based on template samples. A syntax element may be coded to indicate which part of the template (top, left, top-left) is used.

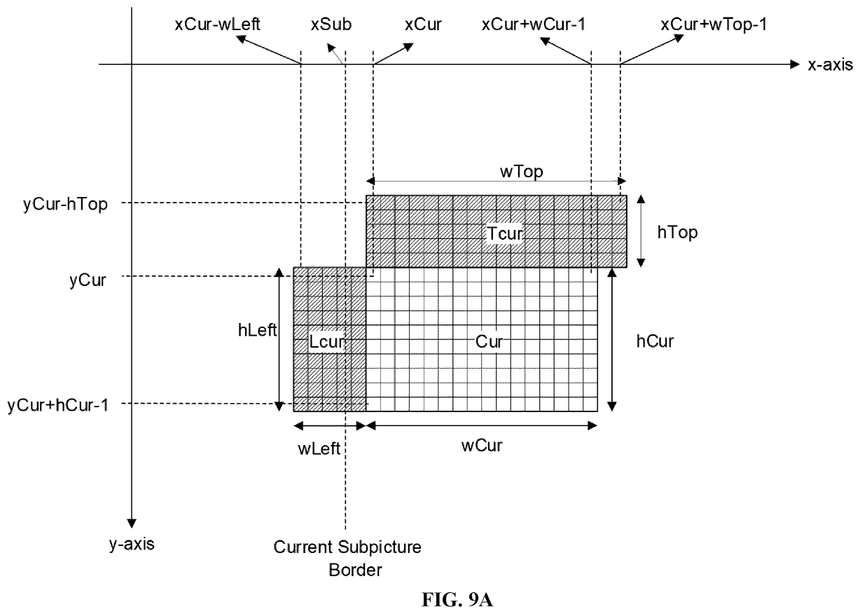

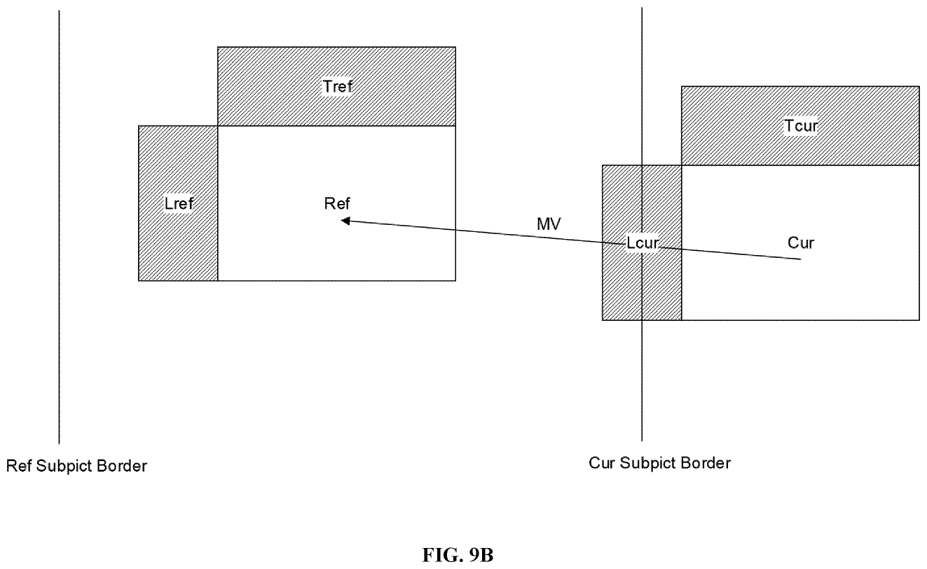

The access to samples in the template area of the current block (current template samples) and of reference block(s) (reference template samples) is not always guaranteed. In particular, when specific structures such as CTUs, slices, tiles, subpictures, are used, it is not clear how template-based tools should behave at the border of such structures. Constraints and restrictions may be required to properly handle template-based tools when used with CTUs, slices, tiles, subpictures, or at picture borders. One main case to consider is when the current block template comprises samples outside a current subpicture. They are also called non-available template samples. In the following the term subpicture is to be understood in its broadest sense and thus covers the subpicture as strictly defined in VVC/ECM but also any picture part such as tile, slice or CTU. This is illustrated in FIG. 9A and FIG. 9B where the current block (Cur) is surrounded by Top (Tcur) and Left (Lcur) template samples, and where the Left template samples are partly outside the current subpicture to which the block Cur belongs. This may be an issue for template-based cross-component coding tools such as CCLM or CCCM that use chroma and luma template of the current block, when the current block chroma and luma templates comprise samples outside the current subpicture (as illustrated in FIG. 9A). On FIG. 9A, each small square corresponds to one sample whose position is at the center of the square. As an example, the top-left sample of Tour is at position (xCur, yCur-hTop), where hTop is the height of Tcur. In the same way, the top-left sample of Lcur is at position (xCur-wLeft, yCur), where wLeft is the width of Lcur.

This may also be an issue in case of template matching (intra or inter) as illustrated on FIG. 9B. On this figure, the reference block (Ref) that is identified by a motion vector (MV) is, in this example, inside the reference subpicture. Its top and left template samples (Tref and Lref) are also inside the reference subpicture. However, it may also happen that Tref or Lref are partly or totally outside the reference subpicture.

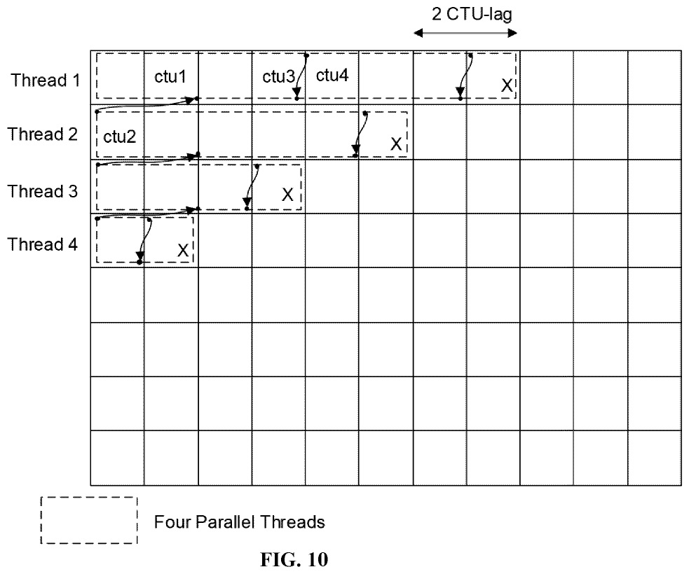

Also, the access to samples in the template area of current block and of reference block(s) in case of Wavefront Parallel Processing (WPP) is not guaranteed. Said otherwise some samples may be non-available because not yet reconstructed. More generally, the interaction of WPP with intra coding tools that involve a displacement vector (a.k.a block vector BV), or the interaction of WPP with history-based coding tools is not always properly handled. Wavefront parallel processing (WPP) allows performing parallel processing of CTUS without impacting significantly the coding performance due to the support of this parallelism. In WPP, rows of CTUs are processed in parallel while preserving all coding dependencies (e.g. for prediction and CABAC). Processing of a CTU requires access to neighboring CTUs (left, top-left, top, and top-right), a shift of at least two CTUs (a.k.a. 2-CTUs lag) being enforced between consecutive rows of CTUs processed in parallel. At the beginning of a CTU row, the CABAC probabilities of a CTU are synchronized with the upper-right CTU. The parallel decoding based on WPP is illustrated on FIG. 10. The arrows show the CABAC states dependencies. For instance, CABAC state of 1st CTU of the second row (ctu2) depends on the CABAC state of top-right CTU in the first row (ctu1). For the next CTUs of the row, their CABAC state depends on the CABAC state of their left CTU. For example, CABAC state of ctu4 depends on CABAC state of ctu3.

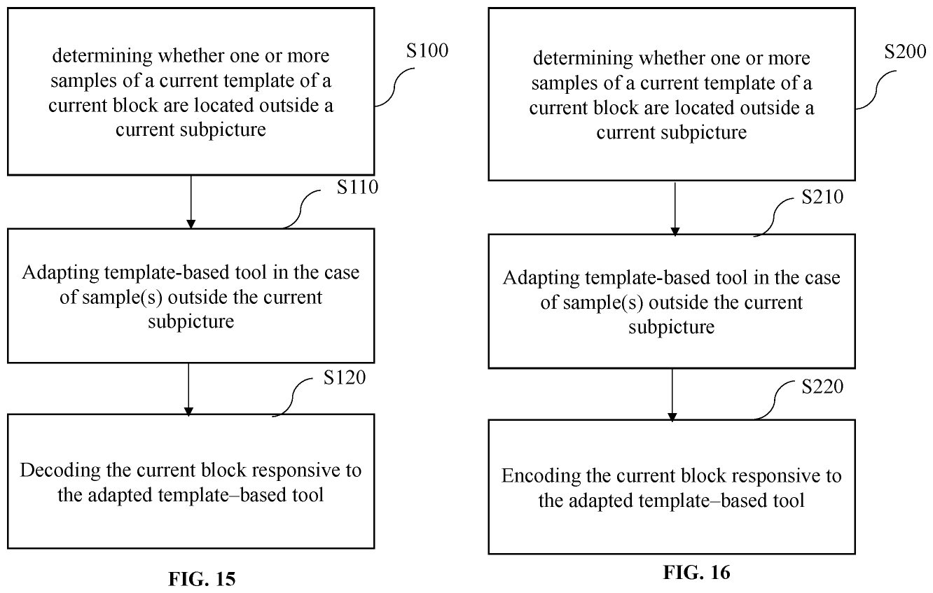

A method for decoding (respectively for encoding) is disclosed with respect to FIG. 15 (FIG. 16 respectively) that makes it possible to properly handle templates of template-based tools for limiting memory needs and accesses at borders of picture structures such as CTUs, slices, tiles, subpictures. The template-based tools may relate to tools that use a template area of the current block (for example CCCM), and when a reference block is required, a template area of the reference block (for example, for intra or inter template matching).

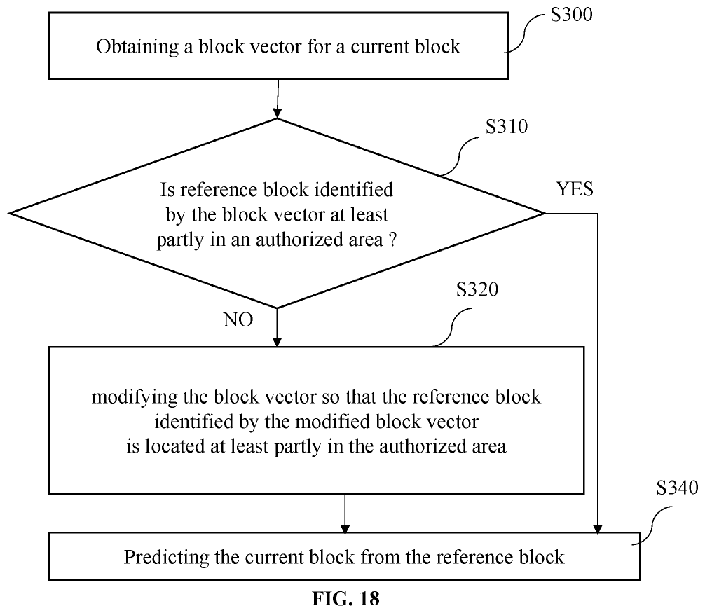

Another decoding method (respectively encoding method) is disclosed using a prediction method disclosed with respect to FIG. 18 that defines constraints on block vector that ensure proper interaction of WPP with intra coding tools that involve a displacement vector or with history-based coding tools.

FIG. 15 depicts a flowchart of a decoding method according to a specific embodiment. The examples disclosed below with respect to a subpicture may apply to any type of structures, e.g. slice, tile, CTU, picture.

At a step S100, it is determined whether at least one sample of a current template of a current block is outside the current subpicture, i.e. is not available. The current block is the block to be decoded and the current subpicture is the subpicture to which the current block belongs.

In an example, the top neighbouring template samples of the current block (Tcur on FIG. 9A) are not available in the case where (yCurr-hTop) is less than ySub otherwise all the samples of the Tour are available, where (xCurr, yCurr) is the luma location of the top-left sample of the current block relative to the top-left luma sample of the current picture, wLeft is the luma left template width, hTop is the luma top template height and (xSub, ySub) is the luma location of the top-left sample of the current subpicture relative to the top-left luma sample of the current picture. In FIG. 9A, the left samples of top template have same x-coordinate as the left samples of the current block. Also, the top samples of left template have same y-coordinate as the top samples of the current block.

In an example, the left neighbouring template samples of the current block (Lcur on FIG. 9A) are not available in the case where (xCurr-wLeft) is less than xSub otherwise all the samples of the Lcur are available.

An example of pseudo-code for checking the availability of samples in current template is provided in table 1 below.

TABLE 1
Derivation process for current template samples availability

Inputs to this process are:

| | |
|---|---|
| - | the luma location ( xSub, ySub ) of the top-left sample of the current subpicture relative |
| | to the top-left luma sample of the current picture, |
| - | the luma location ( xCurr, yCurr ) of the top-left sample of the current block relative to |
| | the top-left luma sample of the current picture, |
| - | the luma template left and top sizes ( wLeft, hTop ). |
| | Output of this process is the availability of the neighbouring template samples of the current |
| | block, denoted as availableL and availableT. |
| | The neighbouring block availability availableL is derived as follows: |
| - | If the following condition is true, availableL is set equal to FALSE: |
| | - ( xCurr − wLeft ) is less than xSub; |
| - | Otherwise, availableL is set equal to TRUE. |

The neighbouring block availability availableT is derived as follows:

| | |
|---|---|
| - | If the following condition is true, availableT is set equal to FALSE: |
| | - ( yCurr − hTop ) is less than ySub; |
| - | Otherwise, availableT is set equal to TRUE. |

The variable named availableT is true in the case where all sample in the part Tcurr of the template are inside the current subpicture and availableL is true in the case where all sample in the part Lcurr of the template are inside the current subpicture.

Additional conditions may also be required for right and bottom borders when the template right and bottom borders go beyond the current subpicture right and bottom borders. This case may for instance arise when the top template width is larger than the current block width, as shown in FIG. 9A, or when the template left height is higher than the current block height. For right borders, top template samples with x-position Sx larger than (xSub+wSub−1) shall be considered as non-available. For bottom borders, left template samples with y-position Sy larger than (ySub+hSub−1) shall be considered as non-available. Here (wSub, hSub) are the width and height of the subpicture. The related conditions can be expressed as follows and apply as additional conditions to the ones described above. The top neighbouring template samples of the current block are not available when (xCurr+wTop−1) is larger than (xSub+wSub−1), that can also be written as (xCurr+wTop) is larger than (xSub+wSub). Similarly, the left neighbouring template samples of the current block are not available when (yCurr+hTop−1) is larger than (ySub+hSub−1), that can also be written as (yCurr+hTop) is larger than (ySub+hSub).

At a step S110, the template-based tool is adapted in the case where one or more than one template samples are outside the current subpicture, i.e. are non-available. Adapting the template-based tool may comprise disabling the template-based tool for the current block or may comprise adapting the template used by the template-based tool.

In one example, the template-based tool is disabled in the case where the current block template comprises at least one sample outside the current subpicture. Based on the pseudo code above, this consists in disabling template-based tool in the case where availableL or availableT is false.

The template-based tool may be also disabled for top template when top template samples are beyond the current subpicture right border, and for left template when left template samples are beyond the current subpicture bottom border.

In another example, the template-based tool is disabled only in the case where a minimum number of samples outside the current subpicture is reached, or when a minimum ratio of samples outside the current subpicture is reached. Or inversely, the template-based tool is enabled only in the case where a minimum number of samples inside the current subpicture is reached, or when a minimum ratio of samples inside the current subpicture is reached. The ratio is for instance defined as the number of template samples inside the subpicture divided by total number of template samples. For example, template-based tool is disabled when (nbNonAvailableL+nbNonAvailableT) is larger than lmin*(wTop*hTop+wLeft*hLeft), where lmin is a threshold either predefined or signaled in the bitstream, nbNonAvailableL=Max(0, (xSub−(xCurr−wLeft)))*hLeft and nbNonAvailableT=Max(0, (ySub−(yCurr−hTop)))*wTop, wCur and hCur being respectively the width and height of the current luma block. Example of possible values for lmin are 0.25 or 0.5.

In this example, it is supposed that the top template width is the same as the current block width, and the template left height is the same as the current block height. If this is not the case, nbNonAvailableT should be increased by Max(0, (xSub+wSub)−(xCurr+wTop)), and nbNonAvailableL should be increased by Max(0, (ySub+hSub)−(yCurr+hTop)).

In a variant, the use of top template is disabled when the number of non-available top samples is above a ratio of the total number of top samples, which can be expressed as: top template is disabled when nbNonAvailableT>lmin*(wTop*hTop). Similarly, the use of left template is disabled when the number of non-available left samples is above a ratio of the total number of left samples, which can be expressed as: left template is disabled when nbNonAvailableL>lmin*(wLeft*hLeft). In a variant, the ratio for the top samples and the ratio for the left samples are different. In another variant, the ratio for the top samples and the ratio for the left samples depend on the current block dimensions (a.k.a size).

An example of pseudo-code for obtaining the number of samples outside the current subpicture is provided in Table 2 below.

TABLE 2
Derivation process of number of non-available current template samples

Inputs to this process are:

| | |
|---|---|
| - | the luma location ( xSub, ySub ) of the top-left sample of the current subpicture relative |
| | to the top-left luma sample of the current picture, |
| - | the luma location ( xCurr, yCurr ) of the top-left sample of the current block relative to |
| | the top-left luma sample of the current picture, |
| - | the luma width wCur and height hCur of the current block, |
| - | the luma template left and top sizes ( wLeft, hTop ). |

```
Output of this process is the number of non-available current template samples of the current
block, denoted as nbNonAvailableL and nbNonAvailableT.
nbNonAvailableL is derived as follows:
  nbNonAvailableL = Max(0, xSub − (xCurr − wLeft ) ) * hLeft
nbNonAvailableT is derived as follows:
  nbNonAvailableT = Max(0, ySub − ( yCurr − hTop ) ) * wTop
```

In another example, the template-based tool is enabled but the template used by the template-based tool is adapted.

Adapting the template may comprise not using the current top and/or left template part(s) for deriving a distortion or statistical parameter(s) in the case where some current top/left template samples are outside the current subpicture. For example, as illustrated in FIG. 11A, the current left template Lcur is removed because some current left template samples are outside the current subpicture. Said otherwise, the current left template Lcur is not used when availableL is false, and the current top template Tour is not used when availableT is false. As an example, the current left template Lcur (Tour respectively) is not used to derive statistical parameters in the case of CCLM or CCCM template-based tools when availableL is false (when availableT is false respectively).

In the specific example of template matching, i.e. in the case where a reference block is used, the reference top (left template respectively) is also not used for deriving a distortion in the case where current top samples (left template samples respectively) are outside the current subpicture. For example, as illustrated in FIG. 11B, the reference left template is removed because some current left template samples are outside the current subpicture.

In the case where a whole part of the template (i.e. Lcur or Tcur) is removed from the template, coding a syntax element to indicate which part of the template (top, left or both top-left) is used may be adapted based on the availability of the part of the template in the current subpicture. Indeed, in the case where the 3 parts (top, left or both top-left) are available, 2 bits are used to indicate which part is effectively used by the template-based tool. Therefore, in the case where a part (top or left) is removed, the syntax element needs not to be coded and may be inferred. Less bits are thus used. Indeed, on the decoder side, by checking availability of the template parts, the decoder is able to determine which part of the template is used.

Adapting the template may comprise reducing the size of the template at the border of subpictures in the case where some current top/left template samples are outside the current subpicture.

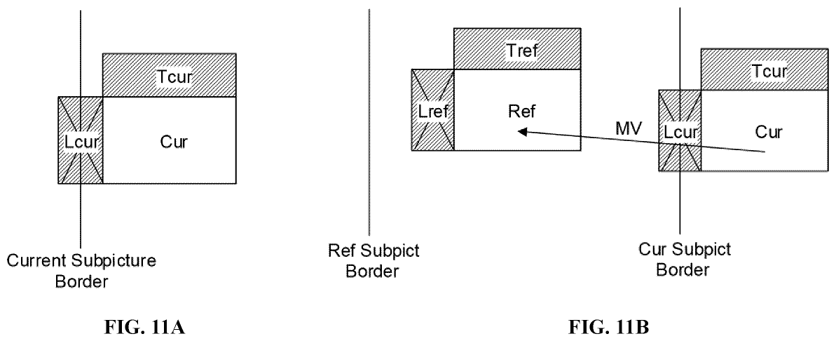

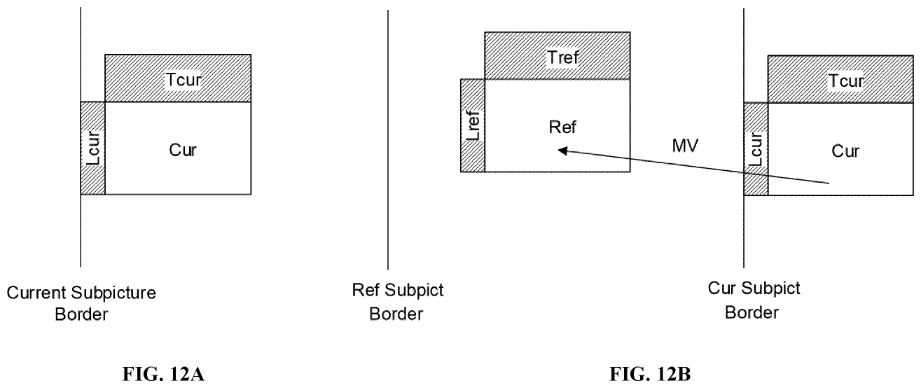

In one embodiment, the template-based tool is enabled and the template shape for the current block and for the reference block(s) if any is modified based on the samples' availability of the current block template samples. For example, as illustrated in FIG. 12A, the template shape of current left template is modified to only include samples inside the current subpicture.

In one embodiment, to have same template shape for the reference block, the reference template shape is modified in the same way as the current template shape as depicted on FIG. 12B.

In a variant of the two embodiments, the template shape is adjusted to ensure that the number of samples in the template is a power of 2, which may reduce the complexional complexity and the internal bit depth required for performing the template matching search.

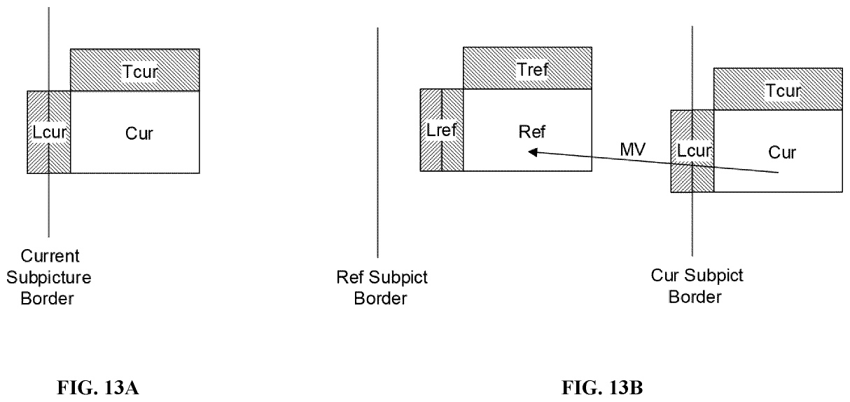

Adapting the template may comprise extrapolating template samples located outside the current subpicture as depicted on FIG. 13A and FIG. 13B.

In one embodiment, the template-based tool is enabled and the current template samples outside of the current subpicture (dashed portion on FIG. 13A) are derived by an extrapolation process such as padding based on available neighboring samples, that is, from samples inside the current subpicture. Another example is to extrapolate a missing sample left (x,y) from available samples left (x+k,y) from right part of the template (located at horizontal coordinate x+k, k>0), according to a linear model: left (k−r,y)=a+b*r where a and b are estimated by least-mean-squares from the available samples left (x−k,y). For example, as illustrated on FIG. 13A, the left template samples located at the left of the current subpicture border (dashed rectangle inside Lcur area) are padded from the left template samples located at the right of the current subpicture border (grey rectangle inside Lcur area). In an example, the left most column of samples in the grey part is copied in all columns of the dashed part.

In one embodiment, the template-based tool is enabled and both the current template samples outside of the current subpicture and its corresponding reference template samples are derived by an extrapolation as illustrated by FIG. 13B. For example, in FIG. 13B, the dashed part of the left template samples of the reference block, i.e. of Lref, is derived by an extrapolation process such as padding based on available neighboring samples, in the same way as the dashed part of Lcur. Left template of current and reference blocks are therefore partly made of “real” samples (grey) and padded samples (dashed). Padding can be done by copying the closest available sample, or by extrapolating from several closest available samples.

In another embodiment that can be combined with both previous embodiments, weighting is applied to the template samples when computing a distortion in template-matching (intra or inter) between the current template samples and the reference template samples or when computing statistical parameters (e.g. in LIC or CCLM), based on the template samples availability. For instance, by default, the weight is equal to 1 for all template samples. When a sample is not available, its weight is set to 0. In another example, the weight can be based on the distance of the template sample to the current block border. For instance, for template samples located R line/row from the closest current block border, the weight is set to ½^{R} or 1/R. The application of a weighting process is described in the equation below.

$$dist = {\sum }_{i = 0}^{N - 1} w ( p ) * \vert Cur ( p ) - Ref ( p ) \vert$$

The distortion may be normalized based on the sum of weights over the complete template, to ensure that distortions computed for different reference blocks are consistent. This leads to the following distortion equation:

$$dist = \frac{{\sum }_{i = 0}^{N - 1} w ( p ) * \vert Cur ( p ) - Ref ( p ) \vert}{{\sum }_{i = 0}^{N - 1} w ( p )}$$

As mentioned previously for LIC, α and β may be computed from intermediate statistical parameters such as min/max samples value, average, inter-correlation, variance. Therefore, as for the distortion, the intermediate statistical parameters may be computed using weights. As an example, the intermediate statistical parameter corresponding to the average may be computed as follows:

$${avg}_{cur} = \frac{{\sum }_{i = 0}^{N - 1} w ( p ) * Cur ( p )}{{\sum }_{i = 0}^{N - 1} w ( p )}$$

$${avg}_{ref} = \frac{{\sum }_{i = 0}^{N - 1} w ( p ) * Ref ( p )}{{\sum }_{i = 0}^{N - 1} w ( p )}$$

In one embodiment, when extrapolation process (for example padding) is applied for non-available template samples, those samples are weighted with a weight lower than the weight of available template samples. For instance, weight for padded template samples is set to ¼ or ½.

In the tool “Non-adjacent spatial candidates” of ECM, the motion vectors can be predicted from motion vectors from the current slice that are not adjacent to the current block. In ECM, there is no line buffer restriction, which means that even for predicting motion of CUs close to CTU borders, motion vectors far from the CTU borders can be used.

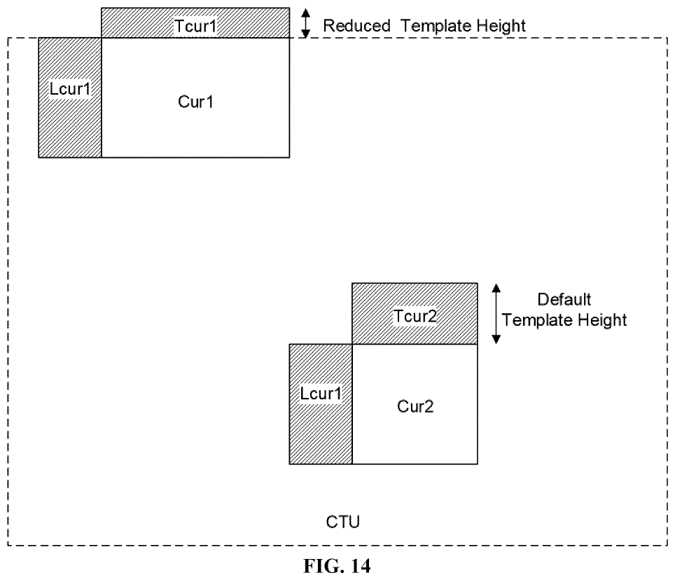

Therefore, in another embodiment, when a current block is at the top or left border of a CTU, the template size is reduced in order to reduce the memory storage needs from previous CTUs. In particular, to limit the memory storage needs from upper line of CTUs, the top template height is reduced for coding blocks located at the top border of the CTU. This case is illustrated in FIG. 14. In this example, the current block Cur1 is located at top border of the CTU. The top template height is reduced by 2 compared to the default template height. The current block Cur2 located far from top border of the CTU can use the default top template height. For instance, by constraining top template height to 1 line for CUs at top CTU border, one 1 line of samples need to be stored for each CTU line. The size of the corresponding reference template may be adjusted to the same as the current template. Alternatively, in order to keep the same number of top template samples as in generic (non-CTU border) case, the missing template samples may be derived by padding from the available template samples.

In a variant, at CTU top border, the top template is not considered, and the template is only made of left samples of the current block. In this case, the coding of the syntax element used to indicate which part of the template (top, left, top-left) is used, is adapted based on the availability in the CTU of the parts of the template. For example, in CCCM, when the 3 parts (top, left, top-left) of the template are available, 2 bits are used to indicate which part is used; when the top part is not available (fully or partly outside of the current CTU), the syntax element is not coded and it is inferred.

At S120, the current block is decoded responsive to the adapted template-based tool.

FIG. 16 depicts a flowchart of an encoding method according to a specific embodiment. The examples disclosed below with respect to a subpicture may apply to any type of structures, e.g. slice, tile, CTU, picture.

At a step S200, it is determined whether at least one sample of a current template of a current block is outside the current subpicture, i.e. is not available. The current block is the block to be decoded and the current subpicture is the subpicture to which the current block belongs.

At a step S210, the template-based tool is adapted in the case where one or more than one template samples are outside the current subpicture, i.e. are non-available. Adapting the template-based tool may comprise disabling the template-based tool for the current block or may comprise adapting the template used by the template-based tool.

The step S200 is identical to S100. The step S210 is identical to S210.

At S220, the current block is encoded responsive to the adapted template-based tool.

The embodiments mentioned above with respect to subpictures and subpicture borders, may be generalized to padded subpictures and borders of padded subpictures. Indeed, similar to the case of pictures, a (current or reference) subpicture may be padded with some margin, to enable using samples slightly outside the subpictures. Instead of considering subpicture borders to restrict or adapt the template-based tool, padded subpicture borders may thus be considered. In this case, (xSub, ySub) are the top-left sample locations in the padded subpicture and (wSub, hSub) specify the padded subpicture width and height.

The embodiments mentioned above with respect to subpictures and subpicture borders, may be generalized to other picture structures, such as tiles, slices, CTUs, Video Decoding Processing Units (VDPUs).

The embodiments related to the adaptations of template-based tools may be combined with the embodiments disclosed below with respect to WPP constraints.

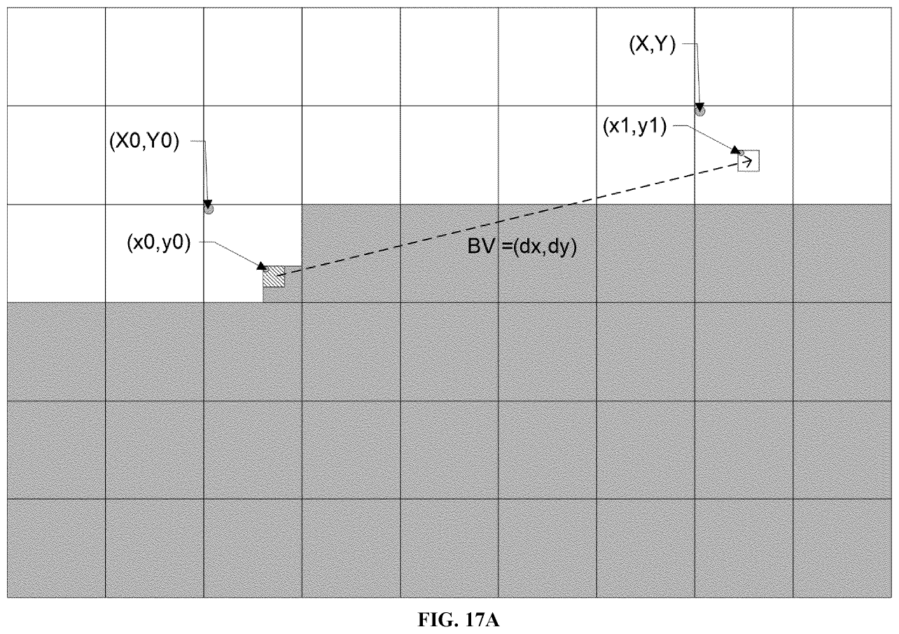

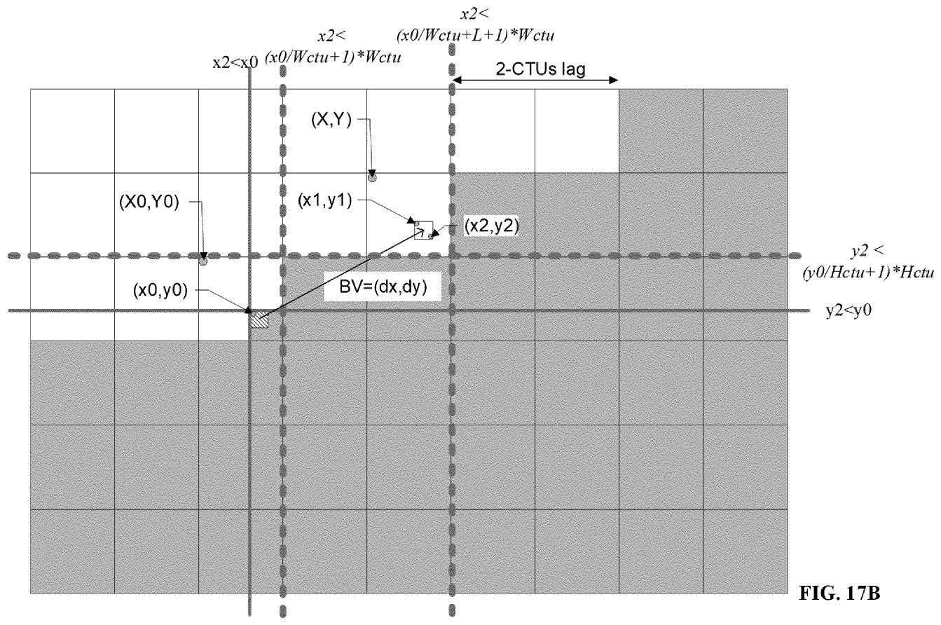

The design of WPP in HEVC and VVC involves that the decoding of a CTU line in a thread has a minimum of 2 CTUs-lag compared to the previous CTU line as depicted on FIG. 10, due to the CABAC dependency of the first CTU of the current CTU line to the second CTU of the previous CTU line. This dependency has impact on the coding dependencies of intra coding tools that may refer to distant/non-adjacent blocks, using block vectors (BVs), e.g. in the case where Intra TMP and its variants and IBC and its variants are used. As illustrated on FIG. 17A and FIG. 17B that represent a picture divided in CTUs. FIG. 17A illustrates a generic case while FIG. 17B illustrates a particular case of WPP with a lag parameter of 2 CTUs. A current block is considered with top-left sample at location (x0,y0) in the picture, in sample unit, which belongs to a CTU with top-left sample at location (X0,Y0)=(x0/Wctu, y0/Hctu) where (X0,Y0) are the CTU coordinates in CTU units, and Wctu and Hctu are the CTU width and height in samples unit. The symbol “/” represents the integer division with truncation of the result toward zero. For its prediction, the current block refers to another block of the same picture using a block vector BV=(dx,dy). The reference block top-left sample is therefore located at position (x1, y1)=(x0+dx,y0+dy) in the picture. When dx or dy is of sub-pel accuracy, (x1, y1) may be rounded to the floor integer values of (x0+dx,y0+dy), or the nearest integer values of (x0+dx,y0+dy). Equivalently, (dx, dy) may be rounded to the floor integer values of (dx,dy), or the nearest integer values of (dx,dy). (x1, y1) belongs to the CTU at position (X,Y)=((x0+dx)/Wctu, (y0+dy)/Hctu). The reference block width is noted Wblk and height is noted Hblk.

In current ECM design, one constraint on such reference blocks (and therefore on the BVs) is that they should be in the preceding CTU lines of the current CTU or in an area already reconstructed in the current CTU line. This is illustrated in FIG. 17A where the reference block belongs to a previously processed CTU in the preceding CTU line. The forbidden area (that cannot be referred to by the BV) is indicated in grey, and the authorized area is indicated in white.

Another basic condition for BV is that the reference block cannot intersect the current block. Given that the top-left sample of the reference block is at (x1,y1), derived as x1=x0+dx and y1=y0+dy and given that the down-right sample of the reference block is at (x2,y2), derived as x2=x0+dx+Wblk−1 and y2=y0+dy+Hblk−1, this basic condition can be expressed by the following clipping condition: (x2<x0) OR (y2<y0), or equivalently by the following clipping condition: (dx<−(Wblk−1)) OR (dy<−(Hblk−1)). This is illustrated by grey continuous lines of FIG. 17B.

A constraint can be expressed as a clipping condition as defined above or alternatively as a bitstream conformance constraint. The clipping conditions are applied by both the encoder and decoder. Therefore, an encoder can transmit values that do not respect the constraint knowing that the decoder would anyway clip the transmitted values to values respecting the constraints. A bitstream conformance constraint requests that the encoder ensures that the transmitted values in the conformant bitstreams respect the constraint. Therefore, a decoder can directly use the transmitted values.

As an example, in VVC the block vector constraint for the IBC mode is expressed as a bitstream conformance constraint. It is expressed in the VVC specification as follows:

It is a requirement of bitstream conformance that the luma block vector bvL shall obey the following constraints:
CtbSizeY is greater than or equal to ((yCb+(bvL[1]>>4)) & (CtbSizeY−1))+cbHeight.
IbcVirBuf[0 ][(x+(bvL[0]>>4)) & (IbcBufWidthY−1)][(y+(bvL[1]>>4)) & (CtbSizeY−1)] shall not be equal to −1 for x=xCb . . . xCb+cbWidth−1 and y =yCb . . . yCb+cbHeight−1.
   where bvL is the luma block vector, IbcVirBuf is a buffer storing already reconstructed samples, with a height of IbcBufWidthY=256*128/CtbSizeY samples, where CtbSizeY is the luma height of a CTU.

Another decoding method (respectively encoding method) is thus disclosed that uses a prediction method illustrated on FIG. 18 that defines constraints on block vector to ensure proper interaction of WPP with coding tools requiring access to data from non-adjacent blocks, e.g. intra coding tools that involve a block vector BV (a.k.a. displacement vector) or inter coding tools using history-based candidate lists. The decoding method (respectively encoding method) constraints the coding tools to access data from a constrained (authorized) area defined from a WPP lag parameter.

The decoding methods disclosed with respect to FIGS. 15 and 18 may be combined. The encoding methods disclosed with respect to FIGS. 16 and 18 may also be combined.

FIG. 18 depicts a flowchart of a prediction method according to a specific embodiment.

At S300, a block vector BV is obtained for a current block to be encoded. The block BV may be obtained using intra template matching prediction as illustrated by FIG. 4 or by block matching as illustrated by FIG. 5.

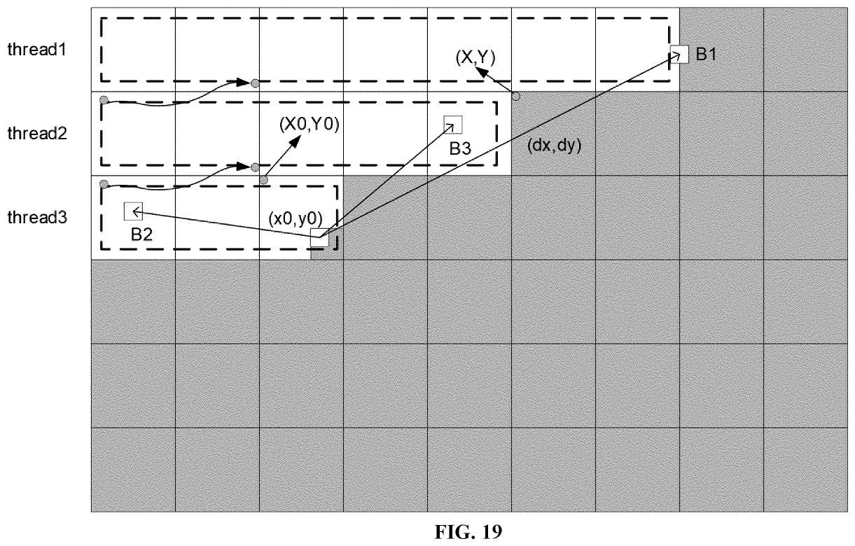

At S310, it is determined whether the reference block identified by the obtained block vector BV is at least partly located in an authorized area (or equivalently whether the reference block is fully outside the authorized area). The authorized area comprises the CTUs already processed by the parallel decoding/encoding (white area on FIG. 17B). This authorized area is determined based on a WPP lag parameter L (a.k.a CTU-lag). L indicates the advance, in CTU unit(s), of a CTU-line decoding/encoding thread, compared to the previous CTU-line decoding/encoding thread. L could, for example, be equal to 2. In an embodiment, the WPP lag parameter may be signaled in the bitstream, e.g. in HLS (High level syntax), in the SPS, PPS, slice header. In one variant, the lag parameter may vary per CTU row (for instance, one lag parameter is signaled per CTU row). FIG. 19 illustrates wavefront parallel decoding of a current block in a case where 3 parallel threads are considered, and the CTU-lag L is equal to 2. In the figure, the forbidden area is indicated in grey, and the authorized area in white. Three examples of reference blocks B1, B2 and B3 belonging partly to the authorized area are illustrated.

In the case where the reference block is not at least partly located in the authorized area, i.e. is fully outside the authorized area, then the block vector is modified at S320 so that the reference block is located at least partly in the authorized area. In this example, in order to support WPP, the block vector is thus constrained/modified to ensure that the reference block belongs at least partly to the authorized area prior to the prediction of the current block at S340. In this case, the current block is predicted at S340 from the reference block identified by the modified block vector. Otherwise (i.e. the reference block identified by the obtained block vector is at least partly located inside the authorized area), the current block is predicted from the reference block at S340. The obtained predicted block may be used on both the encoder and decoder side.

The reference block with top-left sample at position (x0+dx,y0+dy) must belong to a CTU (X,Y) in CTU coordinates verifying the following conditions a) and b) involving the parameter L:
a) Y<=Y0 (Eq.6) meaning that the reference block CTU must be in the current CTU line or in a previous CTU line of the CTU comprising the current block; and
b) X<=X0+L*(Y0−Y) (Eq.7) meaning that the horizontal position of the reference block CTU (X) must be lower than or equal to the horizontal position of the current block CTU (X0), lagged by the lag value L multiplied by the CTU line difference between the current block CTU and the reference block CTU (Y−Y0).

Condition b) ensures that the reference block cannot be taken from a CTU of the picture that has not yet been processed by the WPP. These conditions a) and b) may also be written from the coordinates of the top left sample of the reference block (x0+dy, y0+dy).

The block vector may thus be modified at S320 so that it verifies the following conditions 1) and 2):
1) y1/Hctu <=y0/Hctu or equivalently (y0+dy)/Hctu<=y0/Hctu (Eq. 8),
2) x1/Wctu <=x0/Wctu +L*(y0/Hctu−y1/Hctu) or equivalently (x0+dX)/Wctu<=x0/Wctu+L*(y0/Hctu−(y0+dy)/Hctu) (Eq.9)

These conditions guarantee that the top-left sample (x1, y1) of the reference block is inside the authorized area.

The BV can be modified (by the encoder and the decoder) so that the conditions 1) and 2) are fulfilled. For instance, if the BV=(dx,dy) is such that: (y0+dy)/Hctu>y0/Hctu, meaning that condition 1) is not fulfilled, dy is modified to dy′ so that (y0+dy′)/Hctu<=y0/Hctu. In the same manner, if the BV=(dx,dy) is such that: (x0+dx)/Wctu>x0/Wctu+L*(y0/Hctu−(y0+dy)/Hctu) meaning that condition 2) is not fulfilled, dx is modified to dx′ so that (x0+dx′)/Wctu<=x0/Wctu+L*(y0/Hctu−(y0+dy)/Hctu) or so that (x0+dx′)/Wctu<=x0/Wctu+L*(y0/Hctu−(y0+dy′)/Hctu) in the case where dy is modified to dy′.

Alternatively, these conditions can be expressed in a specification as bitstream conformance constraints in which case the decoded BV fulfill the above constraints (Eq.8 and Eq.9).

The prediction method depicted on FIG. 18 may be applied both at an encoder or decoder side. On the encoder side, encoding the current block comprises subtracting the predicted block from the current block to obtain a residual block that is then transformed, quantized and entropy encoded.

On the decoder side, decoding the current block comprises adding the predicted block to a residual block to obtain a reconstructed block, wherein the residual block is decoded from the bitstream by applying entropy decoding, dequantization and inverse transform.

FIG. 21 illustrates the case of a reference block that is partly inside the authorized area and partly outside such as B1 on FIG. 19. Indeed, the previous conditions on BV specified by Eq.8 and Eq.9 do not constrain the reference block to be fully inside the authorized area. These conditions guarantee that the top-left sample of the reference block is inside the authorized area.

In one variant, the part of the reference block that belongs to the forbidden area is extrapolated from neighboring samples belonging to the authorized area, for example by padding those samples. The padding can be made using the prediction mode used for coding the samples of the reference block. For instance, if the samples of the reference block neighboring the area to pad were coded using a directional mode, the padding is made using the intra prediction direction. This is illustrated in FIG. 21 where the right part of the reference block is inside the forbidden area (grey), and where the samples of the reference block in the forbidden area are interpolated from neighboring samples in the authorized area (dashed area) along the intra prediction direction (indicated by the arrow). In another variant, those samples are set to a default value, for instance 2B-1 where B is the bit depth of the signal. Other common padding or inpainting methods can be applied.

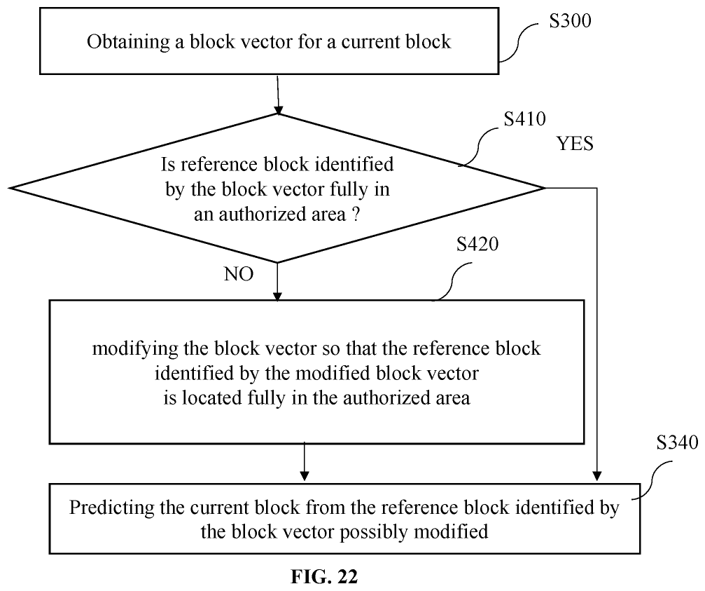

FIG. 22 depicts a flowchart of a prediction method according to a variant of the method depicted on FIG. 18. The method comprises the steps S300 and S340 while S310 and S320 are modified.

At S410, it is determined whether the reference block identified by the obtained block vector BV is fully inside the authorized area. In the case where the reference block is not fully inside the authorized area, then the block vector is modified at S420 so that the reference block is located fully in the authorized area. In this example, in order to support WPP, the block vector is thus constrained/modified to ensure that the reference block belongs fully to the authorized area prior to the prediction of the current block at S340. Otherwise (i.e. the reference block identified by the obtained block vector is fully inside the authorized area), the current block is predicted from the reference block at S340.

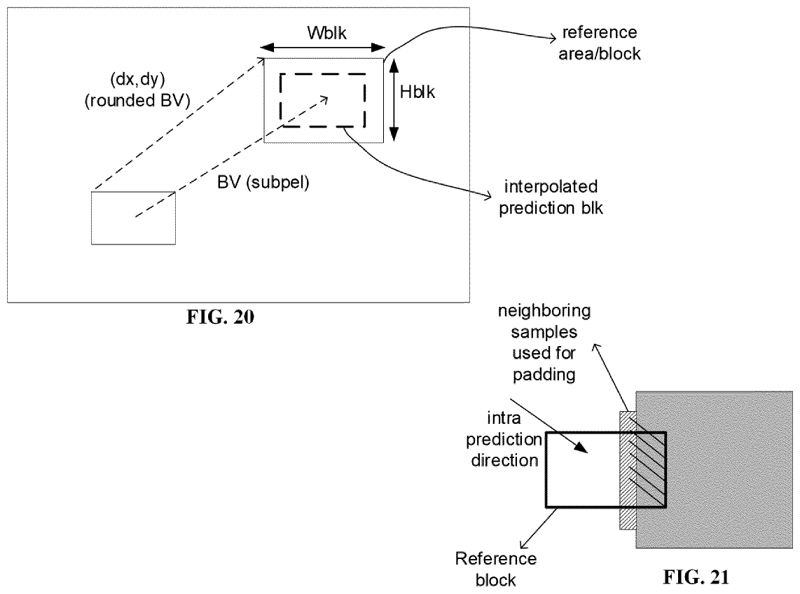

In this example, the reference block of width Wblk, of height Hblk, must be fully inside the authorized area. Said otherwise, it cannot be partly included inside the forbidden area. This means that the down-right sample (x2,y2) of the reference block (or of the reference area required for generating the interpolated reference samples as illustrated on FIG. 20) must be inside the authorized area. Looking at the particular example of FIG. 17B, the conditions to guarantee that the reference block is fully inside the authorized area would be defined by the following equation (Eqs 10) with dY being the CTU line difference with respect to the current CTU line.
If (x1,y1) is in current CTU line, dY=0, the conditions are x2<(x0/Wctu+1)*Wctu and y2<(y0/Hctu+1)*Hctu.
If (x1,y1) is in the CTU line just above the current CTU line, i.e. CTU line minus 1, dY=1, the conditions are x2<(x0/Wctu+L+1)*Wctu and, if x2>=(x0/Wctu+1)*Wctu, y2<(y0/Hctu+1)*Hctu.
If (x1,y1) is in the CTU line preceding the just above CTU line, i.e. CTU line minus 2, dY=2, the conditions are x2<(x0/Wctu+2*L+1)*Wctu and, if x2>=(x0/Wctu+L+1)*Wctu, y2<(y0/Hctu+1)*Hctu.

The conditions that relate to x2 and y2 are illustrated by grey dashed lines on FIG. 17B.

The conditions to constraint a reference block to be fully inside the authorized area can be generically expressed in the following equations (Eqs 11) with dY=(y0/Hctu)−(y1/Hctu):
X2<(X0/Wctu+dY*L +1)*Wctu
   if (dY==0)
   y2<(y0/Hctu+1)*Hctu
      otherwise
if X2>=(X0/Wctu+(dY−1)*L+1)*Wctu
   y2<(y0/Hctu+1)*Hctu
otherwise, y2/Hctu<=y0/Hctu

Replacing x1,y1,x2,y2 by their full expressions leads to conditions applying to (dx,dy) expressed in the following (Eqs 12) with dY=(y0/Hctu)−((y0+dy)/Hctu):
dX<(X0/Wctu+dY*L+1)*Wctu−(X0+Wctu−1)
if (dY==0)
   dy<(y0/Hctu+1)*Hctu−(y0+Hctu−1)
      otherwise
if dX>=(X0/Wctu+(dY−1)*L+1)*Wctu−(X0+Wctu−1)
   dy<(y0/Hctu+1)*Hctu−(y0+Hctu−1)

FIG. 20 illustrates a specific example, wherein the block vector BV is of sub-pel accuracy. In this case, interpolation of the reference samples using a reference area of larger width or height than the current block may be required. The reference area is made of the reference block plus a margin of samples of size marginX (horizontally) and marginY (vertically) around the reference block. In a variant, the constraint on BV takes into account the reference block margins required for generating the interpolated samples. For instance, (dx,dy) may be considered as a rounded version of the BV in Eq.8 and 9, or in Eqs 10,11,12, pointing to the top-left sample of the reference area required for subpel samples interpolation, and (Wblk, Hblk) may be considered as the size of the reference area required for the interpolation of the reference samples to generate the prediction block of the current block.

For instance, Eqs. 11 are changed by integrating the margin parameter, as follows:
(X0+dX+Wblk−1 +marginX)<(X0/Wctu+dY*L+1)*Wctu
if (dY==0)
   (y0+dy+Hblk−1+marginY)<(y0/Hctu+1)*Hctu
      otherwise
if (X0+dX+Wblk−1+marginX)>=(X0/Wctu+(dY−1)*L+1)*Wctu
   (y0+dy+Hblk−1+marginY)<(y0/Hctu+1)*Hctu
otherwise, (y0+dy+Hblk−1+marginY)/Hctu<=y0/Hctu

These conditions can be normatively imposed by the following options. In a first option, these conditions are imposed as bitstream conformance constraints that an encoder must fulfill to ensure bitstream conformance. In a second option, these conditions are imposed by applying clipping constraints to (dx,dy) on both the encoder and decoder side as mentioned in the following (Eqs 13). dY is set to the value (y0/Hctu)−((y0+dy)/Hctu). The value dx is clipped to Min (dx, (x0/Wctu+dY*L+1)*Wctu−(x0+Wctu−1)−1). If (dY==0), the value dy is clipped to Min (dy, (y0/Hctu+1)*Hctu−(y0+Hctu−1)−1). Otherwise (i.e. if dY≠0), if dx>=(x0/Wctu+(dY−1)*L+1)*Wctu−(x0+Wctu−1), the value dy is clipped to Min (dy, (y0/Hctu+1)*Hctu−(y0+Hctu−1)−1).

In another variant not depicted on the previous figures, when intra TMP is used, the block vector BV is constrained to ensure that the template area of the reference block belongs partly or fully to the area comprising the CTUs already processed by the parallel decoding, the area being determined based on a WPP lag parameter (L). This constraint is added to the previous constraint that the reference block is inside the authorized area. This case may arise when the template is larger than the reference block width, or higher than the reference block height, and has samples that go beyond the right border of the reference block, or below the bottom border of the reference block. In this case, even if the reference block is fully inside the authorized area, samples from the template may be outside the authorized area (inside the forbidden area).

In another variant, the part of the template of the reference block that belongs to the forbidden area is extrapolated from neighboring samples belonging to the authorized area, for example by padding those samples, or by an inpainting method. In another variant, those samples are set to a default value, for instance 2B-1 where B is the bit depth of the signal.

In VVC as well as in ECM, motion vector candidates can be obtained from an History-based candidate list. This list is progressively built while the encoding/decoding of a slice or picture is performed. New motion vectors appearing during the encoding/decoding are added to the list, and oldest ones are removed when the list is full. Hence, when processing a current block or CU, the History-based candidate list may be made of motion vectors from CUs that are far from the current CU. Similarly, candidates can be derived from a non-adjacent area of the current block or CU. The non-adjacent area can be of large size.

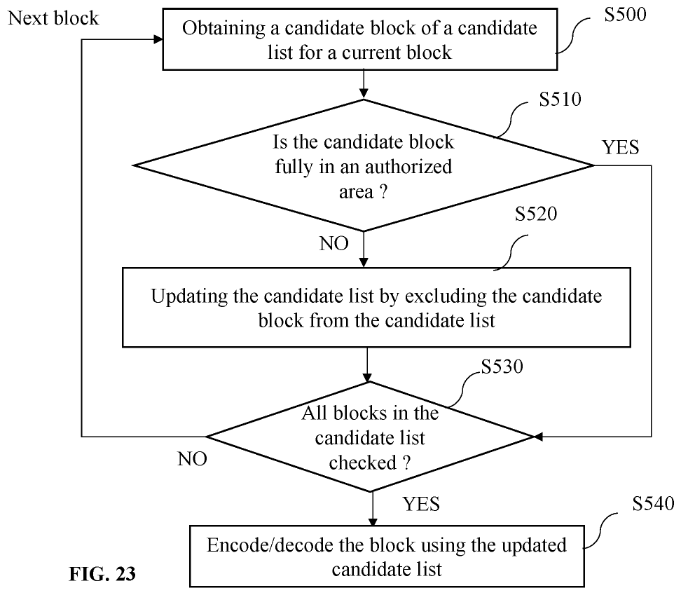

FIG. 23 depicts a flowchart of a method for updating a candidate list of a current block according to an embodiment. Indeed, when History-based candidate list derivation is used, the constraints described above for the block vector BV can be used to limit the area used to derive the History-based candidate list and the non-adjacent spatial candidates. In an embodiment, all candidates in the History-based candidate list must have been derived from coding blocks belonging to the authorized area. In another embodiment, all candidates in the non-adjacent spatial candidates list must have been derived from coding blocks belonging to the authorized area.

This means that a History-based candidate information or a non-adjacent information extracted from location (x1,y1) or (x2,y2) (when the information is extracted from a coded block) must be obtained from a coded block belonging to the authorized area, either partly (only position (x1,y1) is checked using by Eqs 8 and 9) or fully (position (x2,y2) is checked using Eqs 11). In the case where a candidate does not fulfil the conditions, it is excluded from the History-based candidate list or from the non-adjacent spatial candidates list.

At S500, a candidate block of a candidate list is obtained for a current block.

At S510, it is determined whether the candidate block is fully located in the authorized area. In the case where the candidate block is not fully inside the authorized area, then the candidate list is updated by excluding the candidate block from the candidate list at S520. Said otherwise, the candidate block is excluded from the candidate list in the case where it is fully or partly located outside the authorized area.

The steps S500 to S520 are repeated until all candidate blocks of the list are checked (S530).

At S540, the current block is decoded (encoded respectively) using the updated candidate list. In a variant not represented on FIG. 23, at S510, it is determined whether the candidate block is at least partly located in the authorized area or equivalently whether the candidate block is fully located outside the authorized area. In the case where the candidate block is fully outside the authorized area, then the candidate list is updated by excluding the candidate block from the candidate list at S520. Said otherwise, the candidate block is excluded from the candidate list in the case where it is fully located outside the authorized area.

The present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a value of CTU-lag. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

In an example, a decoding method is disclosed that comprises:
determining whether one or more samples of a current template of a current picture block are located outside a current subpicture;
adapting a template-based tool responsive to the determining; and
decoding the current picture block from the adapted template-based tool.

In an example, adapting the template-based tool responsive to the determining comprises disabling the template-based tool in the case where at least one sample, or a given number of samples, or a given ratio of samples are located outside the current subpicture.

In an example, adapting the template-based tool responsive to the determining comprises enabling the template-based tool in the case where a given number of samples, or a given ratio of samples are located inside the current subpicture.

In an example, wherein the current template comprises a top part and a left part respectively, adapting the template-based tool responsive to the determining comprises modifying the current template by removing the top part, the left part respectively, from the current template in the case where at least one sample of the top part, of the left part respectively, is located outside the current subpicture.

In an example, adapting the template-based tool responsive to the determining comprises modifying the current template by removing only the samples located outside the current subpicture from the current template.

In an example, adapting the template-based tool responsive to the determining comprises modifying the current template by removing at least all the samples located outside the current subpicture from the current template and further removing additional samples located inside the current subpicture to ensure that a number of samples in the current template is a power of 2.

In an example, adapting the template-based tool responsive to the determining comprises modifying the current template by extrapolating the samples located outside the current subpicture from neighboring samples located inside the current subpicture.

In an example, in case of template matching using a reference template, the reference template is modified in the same way as the current template.

In an example, decoding the current picture block from the adapted template-based tool comprises computing distortion or parameters from the samples in the current template wherein the samples are weighted by weights whose value is higher for samples located inside the current subpicture than for samples located outside the current subpicture.

In an example, adapting the template-based tool responsive to the determining comprises reducing a size of the current template at a border of a coding tree unit.

An encoding method is disclosed that comprises:
determining whether one or more samples of a current template of a current picture block are located outside a current subpicture;
adapting a template-based tool responsive to the determining; and
encoding the current picture block from the adapted template-based tool.

In an example, adapting the template-based tool responsive to the determining comprises disabling the template-based tool in the case where at least one sample, or a given number of samples, or a given ratio of samples are located outside the current subpicture.

In an example, adapting the template-based tool responsive to the determining comprises enabling the template-based tool in the case where a given number of samples, or a given ratio of samples are located inside the current subpicture.

In an example, wherein the current template comprising a top part and a left part respectively, adapting the template-based tool responsive to the determining comprises modifying the current template by removing the top part, the left part respectively, from the current template in the case where at least one sample of the top part, of the left part respectively, is located outside the current subpicture.

In an example, adapting the template-based tool responsive to the determining comprises modifying the current template by removing only the samples located outside the current subpicture from the current template.

In an example, adapting the template-based tool responsive to the determining comprises modifying the current template by removing at least all the samples located outside the current subpicture from the current template and further removing additional samples located inside the current subpicture to ensure that a number of samples in the current template is a power of 2.

In an example, adapting the template-based tool responsive to the determining comprises modifying the current template by extrapolating the samples located outside the current subpicture from neighboring samples located inside the current subpicture.

In an example, in case of template matching using a reference template, the reference template is modified in the same way as the current template.

In an example, encoding the current picture block from the adapted template-based tool comprises computing distortion or parameters from the samples in the current template wherein the samples are weighted by weights whose value is higher for samples located inside the current subpicture than for samples located outside the current subpicture.

In an example, adapting the template-based tool responsive to the determining comprises reducing a size of the current template at a border of a coding tree unit.

In an example, a prediction method is disclosed that comprises:
obtaining a block vector for a current picture block;
determining whether a reference block identified by the block vector is at least partly inside an authorized area, wherein the authorized area is a picture area already processed;
modifying the block vector so that the reference block identified by the modified block vector is located at least partly in the authorized area responsive to the determining; and
predicting the current picture block from a reference block identified by the modified block vector.

In an example, the authorized area is defined from a lag parameter of wavefront parallel processing.

In an example, the prediction method further comprises padding samples of the reference block located outside the authorized area from neighboring samples located inside the authorized area to obtain a padded reference block and using the padded reference block for predicting the current picture block.

In an example, determining whether a reference block identified by the block vector is partly inside an authorized area comprises determining whether the reference block identified by the block vector is fully inside an authorized area and wherein modifying the block vector comprises modifying the block vector so that the reference block identified by the modified block vector is located fully in the authorized area.

In an example, the reference block is larger than current picture block in case of sub-pel accuracy of block vector.

In an example, predicting the current picture block from a reference block identified by the modified block vector comprises modifying the reference block by extrapolating samples located outside the authorized area from neighboring samples located inside the authorized area and predicting the current picture block from the modified reference block.

An encoding method is disclosed that comprises:
predicting the current picture block from any one of the method of claims 1 to 6 to obtain a predicted block; and
encoding the current picture block from the predicted block.

In an example, the lag parameter.

In an example, encoding the current picture block from the predicted block comprises: determining, for each candidate block of a candidate list, whether the candidate block is outside the authorized area;
updating the candidate list by excluding the candidate block from the candidate list responsive to the determining; and
encoding the current picture block using the updated candidate list.

A decoding method is disclosed that comprises:
predicting the current picture block from any one of the method of claims 1 to 6 to obtain a predicted block; and
decoding the current picture block from the predicted block.

In an example, the lag parameter is decoded.

In an example, decoding the current picture block from the predicted block comprises:
determining, for each candidate block of a candidate list, whether the candidate block is outside the authorized area;
updating the candidate list by excluding the candidate block from the candidate list responsive to the determining; and
decoding the current picture block using the updated candidate list.

A decoding apparatus comprising one or more processors and at least one memory coupled to said one or more processors is disclosed, wherein said one or more processors are configured to perform any of the decoding and prediction methods previously disclosed.

An encoding apparatus comprising one or more processors and at least one memory coupled to said one or more processors is disclosed, wherein said one or more processors are configured to perform any of the encoding and prediction methods previously disclosed.

A computer program comprising program code instructions for implementing any of the methods previously disclosed when executed by a processor.

A computer readable storage medium having stored thereon instructions for implementing any of the methods previously disclosed.

1-16. (canceled)

17. A decoding method comprising:
determining whether one or more samples of a current template of a current picture block are located outside a current subpicture;
adapting a template-based tool responsive to the determining; and
decoding the current picture block from the adapted template-based tool.

18. The decoding method of claim 17, wherein adapting the template-based tool responsive to the determining comprises disabling the template-based tool in the case where at least one sample, or a given number of samples, or a given ratio of samples are located outside the current subpicture.

19. The decoding method of claim 17, wherein adapting the template-based tool responsive to the determining comprises enabling the template-based tool in the case where a given number of samples, or a given ratio of samples are located inside the current subpicture.

20. The decoding method of claim 17, wherein the current template comprising a top part and a left part respectively, adapting the template-based tool responsive to the determining comprises modifying the current template by removing the top part, the left part respectively, from the current template in the case where at least one sample of the top part, of the left part respectively, is located outside the current subpicture.

21. The decoding method of claim 17, wherein adapting the template-based tool responsive to the determining comprises modifying the current template by removing only the samples located outside the current subpicture from the current template.

22. The decoding method of claim 17, wherein adapting the template-based tool responsive to the determining comprises modifying the current template by removing at least all the samples located outside the current subpicture from the current template and further removing additional samples located inside the current subpicture to ensure that a number of samples in the current template is a power of 2.

23. The decoding method of claim 17, wherein adapting the template-based tool responsive to the determining comprises modifying the current template by extrapolating the samples located outside the current subpicture from neighboring samples located inside the current subpicture.

24. The decoding method of claim 20, wherein in case of template matching using a reference template, the reference template is modified in the same way as the current template.

25. The decoding method of claim 17, wherein decoding the current picture block from the adapted template-based tool comprises computing distortion or parameters from the samples in the current template wherein the samples are weighted by weights whose value is higher for samples located inside the current subpicture than for samples located outside the current subpicture.

26. The decoding method of claim 17, wherein adapting the template-based tool responsive to the determining comprises reducing a size of the current template at a border of a coding tree unit.

27. An encoding method comprising:
determining whether one or more samples of a current template of a current picture block are located outside a current subpicture;
adapting a template-based tool responsive to the determining; and
encoding the current picture block from the adapted template-based tool.

28. The encoding method of claim 27, wherein adapting the template-based tool responsive to the determining comprises disabling the template-based tool in the case where at least one sample, or a given number of samples, or a given ratio of samples are located outside the current subpicture.

29. The encoding method of claim 27, wherein adapting the template-based tool responsive to the determining comprises enabling the template-based tool in the case where a given number of samples, or a given ratio of samples are located inside the current subpicture.

30. The encoding method of claim 27, wherein the current template comprising a top part and a left part respectively, adapting the template-based tool responsive to the determining comprises modifying the current template by removing the top part, the left part respectively, from the current template in the case where at least one sample of the top part, of the left part respectively, is located outside the current subpicture.

31. The encoding method of claim 27, wherein adapting the template-based tool responsive to the determining comprises modifying the current template by removing only the samples located outside the current subpicture from the current template.

32. A decoding apparatus comprising one or more processors and at least one memory coupled to said one or more processors, wherein said one or more processors are configured to perform:
determining whether one or more samples of a current template of a current picture block are located outside a current subpicture;
adapting a template-based tool responsive to the determining; and
decoding the current picture block from the adapted template-based tool.

33. The decoding apparatus of claim 32, wherein adapting the template-based tool responsive to the determining comprises disabling the template-based tool in the case where at least one sample, or a given number of samples, or a given ratio of samples are located outside the current subpicture.

34. The decoding apparatus of claim 32, wherein adapting the template-based tool responsive to the determining comprises enabling the template-based tool in the case where a given number of samples, or a given ratio of samples are located inside the current subpicture.

35. An encoding apparatus comprising one or more processors and at least one memory coupled to said one or more processors, wherein said one or more processors are configured to perform:
determining whether one or more samples of a current template of a current picture block are located outside a current subpicture;
adapting a template-based tool responsive to the determining; and
encoding the current picture block from the adapted template-based tool.

36. The encoding apparatus of claim 35, wherein adapting the template-based tool responsive to the determining comprises disabling the template-based tool in the case where at least one sample, or a given number of samples, or a given ratio of samples are located outside the current subpicture.

37. The encoding apparatus of claim 35, wherein adapting the template-based tool responsive to the determining comprises enabling the template-based tool in the case where a given number of samples, or a given ratio of samples are located inside the current subpicture.
